(19) United States
(12) Patent Application Publication
(10) Pub. No.: US 2025/0267088 A1
(43) Pub. Date: Aug. 21, 2025

(54) METHODS, SYSTEMS, AND COMPUTER READABLE MEDIA FOR SYNTHETIC MONITORING OF NETWORK FUNCTION (NF) SERVICE INSTANCES AND AUTOMATED UPDATING OF ROUTING RULES BY SERVICE COMMUNICATION PROXY (SCP)

(71) Applicant: Oracle International Corporation, Redwood Shores, CA (US)

(72) Inventors: Virendra Singh, Bangalore (IN); Shashikiran Bhalachandra Mahalank, Bangalore (IN); Jay Rajput, Bangalore (IN)

(21) Appl. No.: 18/581,214

(22) Filed: Feb. 19, 2024

(51) Int. Cl. H04L 43/0882; H04L 45/24; H04L 47/125

(52) U.S. Cl. CPC H04L 43/0882; H04L 45/24; H04L 47/125

(57) ABSTRACT

A method for synthetic monitoring and updating of routing rules by a service communication proxy (SCP) includes identifying, by an SCP, candidate producer NF service instances for synthetic monitoring. The method further includes for each of the candidate producer NF service instances: testing, by the SCP, the candidate producer NF service instance using the synthetic monitoring; determining, by the SCP, results of the synthetic monitoring; and updating, by the SCP and based on the results of the synthetic monitoring, routing rules in a routing database maintained by the SCP.

### TECHNICAL FIELD

The subject matter described herein relates to monitoring the status of NF service instances. More particularly, the subject matter described herein relates to methods, systems, and computer readable media for synthetic monitoring of NF service instances and automated updating of routing rules by an SCP.

### BACKGROUND

In 5G telecommunications networks, a network function that provides service is referred to as a producer NF or NF service producer. A network function that consumes services is referred to as a consumer NF or NF service consumer. A network function can be a producer NF, a consumer NF, or both, depending on whether the network function is consuming, producing, or consuming and producing services. The terms “producer NF” and “NF service producer” are used interchangeably herein. Similarly, the terms “consumer NF” and “NF service consumer” are used interchangeably herein.

A given producer NF may have many service endpoints, where a service endpoint is the point of contact for one or more NF instances hosted by the producer NF. The service endpoint is identified by a combination of Internet protocol (IP) address and port number or a fully qualified domain name (FQDN) that resolves to an IP address and port number on a network node that hosts a producer NF. An NF service instance is an instance of a producer NF that provides a service. A given producer NF instance may include more than one NF service instance if the producer NF instance provides multiple services. It should also be noted that multiple producer NF instances can share the same service endpoint.

NFs register with a network function repository function (NRF). The NRF maintains profiles of available NF instances identifying the services supported by each NF instance. The profile of an NF instance is referred to in 3GPP TS 29.510 as an NF profile. NF instances can obtain information about other NF instances that have registered with the NRF through the NF discovery service operation. According to the NF discovery service operation, a consumer NF sends an NF discovery request to the NRF. The NF discovery request includes query parameters that the NRF uses to locate the NF profiles of producer NFs capable of providing the service identified by the query parameters. NF profiles are data structures that define the type of service provided by an NF instance as well as contact and capacity information regarding the NF instance.

A service communication proxy (SCP) can also invoke the NF discovery service operation to learn about available producer NF instances. The case where the SCP uses the NF discovery service operation to obtain information about producer NF instances on behalf of consumer NFs is referred to as delegated discovery. Consumer NFs connect to the SCP, and the SCP load balances traffic among producer NF service instances that provide the required services or directly routes the traffic to the destination producer NF instances.

One problem that may occur in 5G and subsequent generation networks relates to routing efficiency. In 5G networks, the SCP routes service-based interface (SBI) messages between NFs. The SCP uses NF information obtained from the NRF to create routing rules. One problem with using information from the NRF to create routing rules is that the information from the NRF may be stale or out of date. As a result, the SCP may route messages to an unavailable or unreachable NF, and the messages may not be properly processed. The SCP and/or the consumer NF will then be required to reroute the messages to an alternate destination. Another problem with relying on information derived from the NRF to generate routing rules is that the information may not be of sufficient granularity. For example, the information obtained from the NRF may indicate that an NF service instance is registered and thus available for routing, but may not include operational information, such as whether the NF service instance is running the most current software version or is correctly configured.

In light of these and other difficulties, there exists a need for improved methods systems and computer readable media for monitoring NF status and for updating routing rules used by an SCP.

### SUMMARY

A method for synthetic monitoring and updating of routing rules by a service communication proxy (SCP) includes identifying, by an SCP, candidate producer NF service instances for synthetic monitoring. The method further includes for each of the candidate producer NF service instances: testing, by the SCP, the candidate producer NF service instance using the synthetic monitoring; determining, by the SCP, results of the synthetic monitoring; and updating, by the SCP and based on the results of the synthetic monitoring, routing rules in a routing database maintained by the SCP.

According to another aspect of the subject matter described herein, identifying candidate producer NF service instances for synthetic monitoring includes receiving, from an NF repository function (NRF) NF discovery responses including NF service profiles of the candidate producer NF service instances, creating, from the NF service profiles, a routing database including routing rules for routing SBI request messages to the candidate producer NF service instances, and selecting the candidate producer NF service instances from the routing database.

According to another aspect of the subject matter described herein, testing the candidate producer NF service instance using synthetic monitoring includes generating, for the candidate producer NF service instance, at least one synthetic service-based interface (SBI) request message, transmitting the at least one synthetic SBI request message to the candidate producer NF service instance, and receiving at least one SBI response message to the at least one synthetic SBI request message.

According to another aspect of the subject matter described herein, the method for synthetic routing and updating routing rules includes maintaining, by the SCP, SBI response message templates, and determining the results of the synthetic monitoring includes comparing information elements in the at least one SBI response message to information elements in at least one of the SBI response message templates, determining that the candidate producer NF service instance as healthy when the information elements in the at least one SBI response message match the information elements in the at least one SBI response message template, and determining that the candidate producer NF service instance as unhealthy when at least one of the information elements in the at least one SBI response message does not match at least one of the information elements in the at least one SBI response message template.

According to another aspect of the subject matter described herein, updating the routing rules includes indicating that the candidate producer NF service instance is healthy when the candidate producer NF service instance is determined to be healthy.

According to another aspect of the subject matter described herein, updating the routing rules includes removing a routing rule for the candidate producer NF service instance from the routing database or indicating that the candidate producer NF service instance is unhealthy when the candidate producer NF service instance is determined to be unhealthy.

According to another aspect of the subject matter described herein, the method for synthetic monitoring and automatic routing rules updating includes maintaining, by the SCP, synthetic SBI request message templates and generating the at least one synthetic SBI request message includes generating the at least one synthetic SBI request message using at least one of the synthetic SBI request message templates.

According to another aspect of the subject matter described herein, the method for synthetic monitoring and automatic routing rule updating includes, after completion of the synthetic monitoring of one of the producer NF service instances, deleting a resource object created by the synthetic monitoring of the one producer NF service instance.

According to another aspect of the subject matter described herein, generating the at least one synthetic SBI request message includes generating a plurality of synthetic SBI request messages that form an SBI transaction, transmitting at least one synthetic SBI request message to the candidate producer NF service instance includes transmitting the plurality of synthetic SBI request messages to the candidate producer NF service instance, receiving at least one SBI response message to the at least one synthetic SBI request message includes receiving SBI response messages to the synthetic SBI request messages, and determining results of the synthetic monitoring includes identifying the candidate producer NF service instance as healthy when the candidate producer NF service instance generates expected SBI response messages to each of the synthetic SBI request messages that form the SBI transaction and identifying the candidate producer NF service instance as unhealthy when the candidate producer NF service instance fails to generate an expected SBI response message to at least one of the synthetic SBI request messages that form the SBI transaction.

According to another aspect of the subject matter described herein, testing the candidate producer NF service instance using the synthetic monitoring includes periodically testing the candidate producer NF service instance using the synthetic monitoring, determining results of the synthetic monitoring includes periodically determining results of the synthetic monitoring, and updating the routing rules maintained by the SCP includes periodically updating the routing rules maintained by the SCP.

According to another aspect of the subject matter described herein, a system for synthetic monitoring and updating of routing rules includes a service communication proxy (SCP) including at least one processor and a memory. The system further includes a service-based interface (SBI) request message routing manager implemented by the at least one processor for identifying, by an SCP, candidate producer NF service instances for synthetic monitoring and, for each of the candidate producer NF service instances: testing the candidate producer NF service instance using the synthetic monitoring, determining, results of the synthetic monitoring; and updating, based on the results of the synthetic monitoring, routing rules in a routing database maintained by the SCP.

According to another aspect of the subject matter described herein, in identifying the candidate producer NF service instances for synthetic monitoring, the SBI request message routing manager is configured to receive, from an NF repository function (NRF) NF discovery responses including NF service profiles of the candidate producer NF service instances, create, from the NF service profiles, a routing database including routing rules for routing SBI request messages to the candidate producer NF service instances, and select the candidate producer NF service instances from the routing database.

According to another aspect of the subject matter described herein, in testing the candidate producer NF service instance using synthetic monitoring, the SBI request message routing manager is configured to generate, for the candidate producer NF service instance, at least one synthetic service-based interface (SBI) request message, transmit the at least one synthetic SBI request message to the candidate producer NF service instance, and receive at least one SBI response message to the at least one synthetic SBI request message.

According to another aspect of the subject matter described herein, the SBI request message routing manager is configured to maintain SBI response message templates, and, in determining the results of the synthetic monitoring the SBI request message routing manager is configured to compare information elements in the at least one SBI response message to information elements in at least one of the SBI response message templates, determine that the candidate producer NF service instance as healthy when the information elements in the at least one SBI response message match the information elements in the at least one SBI response message template, and determine that the candidate producer NF service instance as unhealthy when at least one of the information elements in the at least one SBI response message does not match at least one of the information elements in the at least one SBI response message template.

According to another aspect of the subject matter described herein, in in updating the routing rules, the SBI request message routing manager is configured to indicate that the candidate producer NF service instance is healthy when the candidate producer NF service instance is determined to be healthy, and, in updating the routing rules the SBI request message routing manager is configured to remove a routing rule for the candidate producer NF service instance from the routing database or indicate that the candidate producer NF service instance is unhealthy when the candidate producer NF service instance is determined to be unhealthy.

According to another aspect of the subject matter described herein, the SBI request message routing manager is configured to maintain synthetic SBI request message templates and, in generating the at least one synthetic SBI request message, the SBI request message routing manager is configured to generate generating the at least one synthetic SBI request message using at least one of the synthetic SBI request message templates.

According to another aspect of the subject matter described herein, the SBI request message routing manager is configured to, after completion of the synthetic monitoring of one of the producer NF service instances, delete a resource object created by the synthetic monitoring of the one producer NF service instance.

According to another aspect of the subject matter described herein, in generating the at least one synthetic SBI request message, the SBI request message routing manager is configured to generate a plurality of synthetic SBI request messages that form an SBI transaction, in transmitting at least one synthetic SBI request message to the candidate producer NF service instance, the SBI request message routing manager is configured to transmit the plurality of synthetic SBI request messages to the candidate producer NF service instance, in receiving at least one SBI response message to the at least one synthetic SBI request message, the SBI request message routing manager is configured to receive SBI response messages to the synthetic SBI request messages, and in determining results of the synthetic monitoring, the SBI request message routing manager is configured to identify the candidate producer NF service instance as healthy when the candidate producer NF service instance generates expected SBI response messages to each of the synthetic SBI request messages that form the SBI transaction and identify the candidate producer NF service instance as unhealthy when the candidate producer NF service instance fails to generate an expected SBI response message to at least one of the synthetic SBI request messages that form the SBI transaction.

According to another aspect of the subject matter described herein, in testing the candidate producer NF service instance using the synthetic monitoring, the SBI request message routing manager is configured to periodically test the candidate producer NF service instance using the synthetic monitoring, in determining results of the synthetic monitoring, the SBI request message routing manager is configured to periodically determine results of the synthetic monitoring, and, in updating the routing rules maintained by the SCP, the SBI request message routing manager is configured to periodically updating the routing rules maintained by the SCP.

According to another aspect of the subject matter described herein, a non-transitory computer readable medium having stored thereon executable instructions that when executed by a processor of a computer control the computer to perform steps is provided. The steps include identifying, by a service communication proxy (SCP), candidate producer network function (NF) service instances for synthetic monitoring. The steps further include for each of the candidate producer NF service instances: testing, by the SCP, the candidate producer NF service instance using the synthetic monitoring, determining, by the SCP, results of the synthetic monitoring, and updating, by the SCP and based on the results of the synthetic monitoring, routing rules in a routing database maintained by the SCP.

The subject matter described herein can be implemented in software in combination with hardware and/or firmware. For example, the subject matter described herein can be implemented in software executed by a processor. In one exemplary implementation, the subject matter described herein can be implemented using a non-transitory computer readable medium having stored thereon computer executable instructions that when executed by the processor of a computer control the computer to perform steps. Exemplary computer readable media suitable for implementing the subject matter described herein include non-transitory computer-readable media, such as disk memory devices, chip memory devices, programmable logic devices, and application specific integrated circuits. In addition, a computer readable medium that implements the subject matter described herein may be located on a single device or computing platform or may be distributed across multiple devices or computing platforms.

### BRIEF DESCRIPTION OF THE DRAWINGS

Exemplary implementations of the subject matter described herein will now be explained with reference to the accompanying drawings, of which:

FIG. 1 is a network diagram illustrating an exemplary 5G system network architecture;

FIG. 2 is a message flow diagram illustrating the use of an SCP to route an SBI request message to an Nudm_UEContextManagement (Nudm_UECM) service instance provided by a UDM;

FIG. 3 is a message flow diagram illustrating the use of an SCP to route an SBI request message to an Nudm_UECM service instance provided by a UDM where the Nudm_UECM service instance generates a malformed or incorrect information element in the SBI response message;

FIG. 4 is a message flow diagram illustrating the use of synthetic monitoring to monitor the status of NF service instances and the use of results of the synthetic monitoring to update routing rules used by the SCP to route SBI request messages;

FIG. 5 is a flow chart illustrating an exemplary process performed by the SCP for using synthetic monitoring to monitor the status of NF service instances and to update routing rules;

FIG. 6 is a block diagram illustrating an exemplary architecture of an SCP for performing synthetic monitoring and using the synthetic monitoring to update routing rules; and

FIG. 7 is a flow chart illustrating an exemplary process for performing synthetic monitoring and using results of the synthetic monitoring to update routing rules.

### DETAILED DESCRIPTION

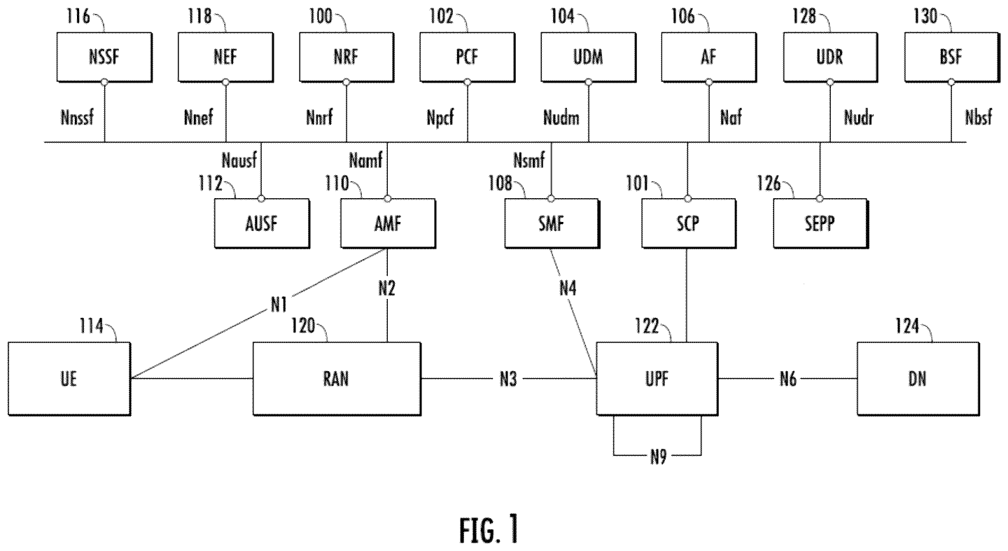

FIG. 1 is a block diagram illustrating an exemplary 5G system network architecture. The architecture in FIG. 1 includes NRF 100 and SCP 101, which may be located in the same home public land mobile network (HPLMN). As described above, NRF 100 may maintain profiles of available NF instances and their supported services and allow consumer NFs or SCPs to subscribe to and be notified of the registration of new/updated NF instances. SCP 101 may also support service discovery and selection of NF instances. SCP 101 may perform load balancing of connections between consumer and producer NFs.

NRF 100 is a repository for profiles of NF instances. To communicate with a producer NF instance, a consumer NF or an SCP must obtain the NF profile of the producer NF instance from NRF 100. The NF profile is a JavaScript object notation (JSON) data structure defined in 3GPP TS 29.510. The NF profile includes attributes that indicate the type of service provided, capacity of the NF instance, and information for contacting the NF instance.

In FIG. 1, any of the network functions can be consumer NFs, producer NFs, or both, depending on whether they are requesting, providing, or requesting and providing services. In the illustrated example, the NFs include a policy control function (PCF) 102 that performs policy related operations in a network, a unified data management function (UDM) 104 that manages user data, and an application function (AF) 106 that provides application services.

The NFs illustrated in FIG. 1 further include a session management function (SMF) 108 that manages sessions between an access and mobility management function (AMF) 110 and PCF 102. AMF 110 performs mobility management operations similar to those performed by a mobility management entity (MME) in 4G networks. An authentication server function (AUSF) 112 performs authentication services for user equipment (UEs), such as user equipment (UE) 114, seeking access to the network.

A network slice selection function (NSSF) 116 provides network slicing services for devices seeking to access specific network capabilities and characteristics associated with a network slice. NSSF 116 provides the NSSelection service, which allows NFs to request information about network slices and the NSSAIReachability service, which enables NFs to update and subscribe to receive notification of updates in network slice selection assistance information (NSSAI) reachability information.

A network exposure function (NEF) 118 provides application programming interfaces (APIs) for application functions seeking to obtain information about Internet of things (loT) devices and other UEs attached to the network. NEF 118 performs similar functions to the service capability exposure function (SCEF) in 4G networks.

A radio access network (RAN) 120 connects user equipment (UE) 114 to the network via a wireless link. Radio access network 120 may be accessed using a gNB (not shown in FIG. 1) or other wireless access point. A user plane function (UPF) 122 can support various proxy functionality for user plane services. One example of such proxy functionality is multipath transmission control protocol (MPTCP) proxy functionality. UPF 122 may also support performance measurement functionality, which may be used by UE 114 to obtain network performance measurements. Also illustrated in FIG. 1 is a data network (DN) 124 through which UEs access data network services, such as Internet services.

SEPP 126 filters incoming traffic from another PLMN and performs topology hiding for traffic exiting the home PLMN. SEPP 126 may communicate with an SEPP in a foreign PLMN which manages security for the foreign PLMN. Thus, traffic between NFs in different PLMNs may traverse two SEPP functions, one for the home PLMN and the other for the foreign PLMN. A unified data repository (UDR) 128 stores subscription data for UEs. A binding support function (BSF) 130 manages bindings between PDU sessions and PCFs.

As stated above, one problem that can occur in 5G and subsequent generation networks is routing inefficiency by the SCP because of stale or insufficiently fine-grained routing information. The SCP enables routing of SBI messages between network functions in 5G core network. The SCP performs routing of messages using routing rules built using NF information derived from the NRF using producer NF service information derived from NF management services (NFListProfileRetreival, NFProfileRetrival, NFStatusSubscribe/NFStatusNotify) and NF discovery services along with received 3 gpp custom headers in received request messages.

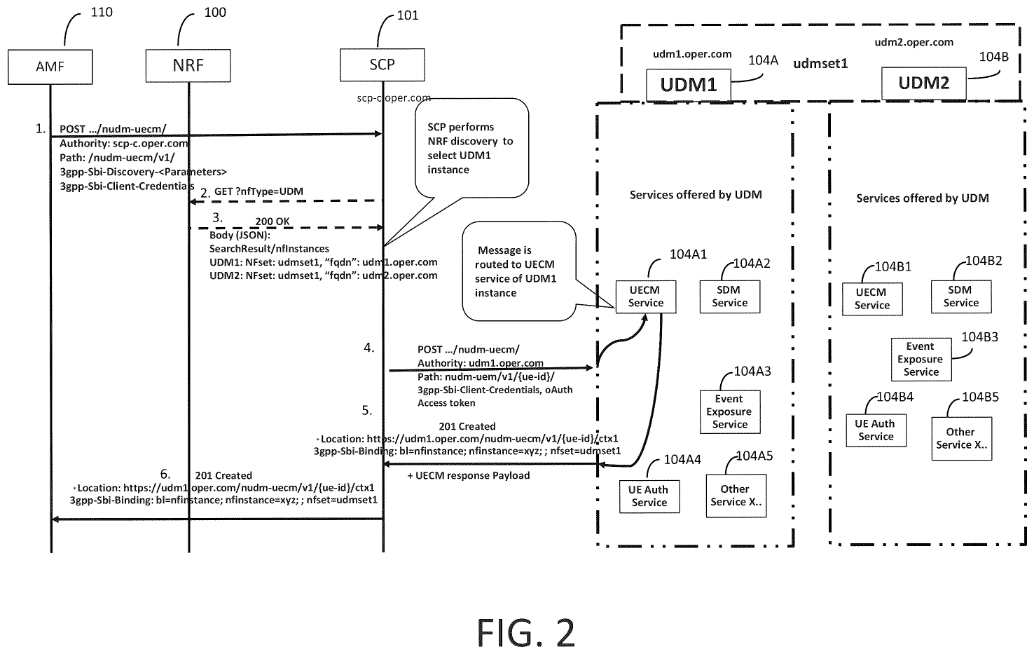

FIG. 2 is a message flow diagram illustrating the use of an SCP to route an SBI request message to an Nudm_UECM service instance provided by a UDM. Referring to FIG. 2, an AMF 110, in step 1, sends an Nudm_UECM request message to access the Nudm_UECM service provided by a UDM. The request message includes NF discovery parameters and client credentials. SCP 101 receives the Nudm_UECM request message and, in step 2, performs NF discovery by sending an NF discovery request message to NRF 100. In step 3, NRF 100 generates and sends an NF discovery response message to SCP 101. The NF discovery response message identifies UDM1 104A and UDM2 104B as being capable of providing the Nudm_UECM service. SCP 101 selects UDM1 104A to provide the service, for example, based on priority and availability parameters in the NF profile information returned in the NF discovery response in step 3. In step 4, SCP 101 sends an Nudm_UECM request message to Nudm_UECM service 104A1 provided by UDM 104A. It should also be noted that UDM1 104A also includes subscriber data management (SDM) service instance 104A2, event exposure service instance 104A3, UE authentication service instance 104A4, and other service instances 104A5. Similarly, UDM2 104B also includes an Nudm_UECM service instance 104B1, an SDM service instance 104B2, an event exposure service instance 104B3, a UE authentication service instance 104B4 and other service instances 104B5.

In step 5, Nudm_UECM service instance 104A1 responds to the Nudm_UECM request by generating and sending an Nudm_UECM response message to SCP 101. In this example, it is assumed that the Nudm_UECM response message includes all of the proper information elements. In step 6, SCP 101 receives the Nudm_UECM response message and sends the Nudm_UECM response message to AMF 110.

Thus, there is no routing inefficiency illustrated in FIG. 2 because Nudm_UECM service instance 104A1 is available and properly processes the Nudm_UECM request. However, routing inefficiencies will occur if the status of an NF service producer maintained by SCP 101 is not up to date and/or insufficiently fine-grained.

Producer NF service instances report health status to the NRF, and health status computation is implementation-specific, for example, based on load/capacity parameters, such as CPU utilization, memory utilization, or transactions per second. This health status may not consider the actual working of service operations as per expectations. Internal software errors, software bugs, incorrect NF service configuration, database corruption, fault implementation behaviors of software, etc., may not be factored into the health status information. Maintaining health status of individual producer NF service instances is voluntary. Health status updates from respective producer NF service instances are communicated to the NRF using NF heart-beat messages or to consumer NF service instances through direct load/overload updates using overload control information/load control information (OCI/LCI) headers in service responses to the consumer NF service instances.

There is no validation available for producer NF service instance working behavior by cross verifying the header and IE level content of SBI messages. As a result, NF producer service instances may behave differently due to different software versions, incorrect configuration, software bugs, etc. The SCP cannot parse and verify all of the headers and IEs of each SBI message, because doing so would add latency to real inter-NF SBI message communications between 5GC NFs and could also lead to request timeouts.

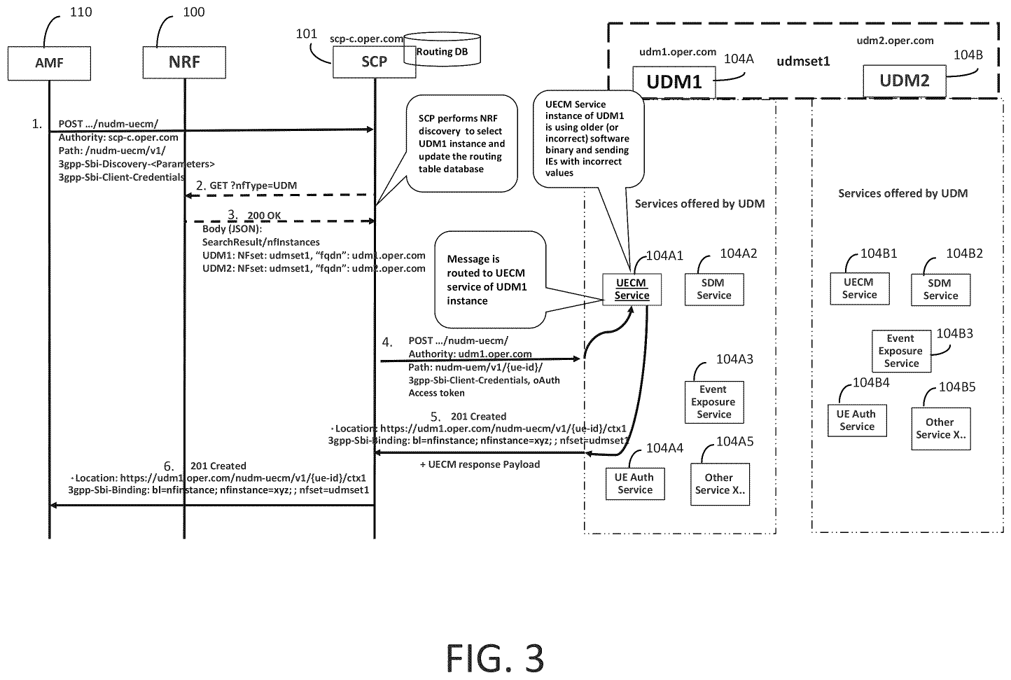

FIG. 3 is a message flow diagram illustrating the use of an SCP to route an SBI request message to an Nudm_UECM service instance provided by a UDM where the Nudm_UECM service instance generates a malformed or incorrect information element in the SBI response message. Referring to FIG. 3, AMF 110, in step 1, sends an Nudm_UECM request message to access the Nudm_UECM service provided by a UDM. The request message includes NF discovery parameters and client credentials. SCP 101 receives the Nudm_UECM request message and, in step 2, performs NF discovery by sending an NF discovery request message to NRF 100. In step 3, NRF 100 generates and sends an NF discovery response message to SCP 101. The NF discovery response message identifies UDM1 104A and UDM2 104B as being capable of providing the Nudm_UECM service. SCP 101 selects UDM1 104A to provide the service, for example, based on priority and availability parameters in the NF profile information returned in the NF discovery response in step 3. In step 4, SCP 101 sends an Nudm_UECM request message to Nudm_UECM service 104A1 provided by UDM 104A.

In the example illustrated in FIG. 3, Nudm_UECM service instance 104A1 is using an incorrect or out of date software version and, as a result, generates responses with incorrect IEs. Accordingly, in step 5, Nudm_UECM service instance 104A1 responds to the Nudm_UECM request by generating and sending an Nudm_UECM response message with incorrect IEs to SCP 101. SCP 101 receives the Nudm_UECM response message and sends the Nudm_UECM response message to AMF 110. AMF 110 detects the incorrect IEs in the response message and is required to repeat the steps illustrated in FIG. 3 to obtain the Nudm_UECM service from an alternate producer NF, such as UDM2 104B.

To avoid or reduce the likelihood of the scenario illustrated in FIG. 3, the SCP described herein periodically performs synthetic monitoring to obtain up to date and fine-grained health information from producer NFs and uses the health information to update routing rules maintained by the SCP. In performing the synthetic monitoring, the SCP simulates real consumer NF service instances and generates periodic synthetic SBI request messages for all producer NF service instances in the routing domain or serving locality of an SCP. The SCP may utilize preconstructed SBI message templates with header and IE values of SBI request messages for each of the service operations of the different SBI interfaces configured at the SCP. Using the network illustrated in FIG. 3 as an example, SCP 101 may generate different synthetic SBI request messages to test the Nudm_UECM service instances, the SDM service instances, the event exposure service instances, the UE authentication service instances, and the other service instances of SCPs 104A and 104B. An SBI request message template usable by SCP 101 to generate the Nudm_UECM service may include the following information elements:

TABLE 1
Nudm_UEContextManagement Request Message Template

| HTTP | | | | Client | Access |
|---|---|---|---|---|---|
| Method | Service Name | Authority | Path | Credentials | Token |
| PUT | Amf3GppAccessRegistration | Authority | URL | Credentials | Access |
| | | for UDM | for | Received | Token |
| | | instance | NF | from | Received |
| | | Received | service | Consumer | from |
| | | from | Instance | NF | Consumer |
| | | NRF | received | | NF |
| | | | from | | |
| | | | NRF | | |

In Table 1, the first row represents the information elements that would be included in the Nudm_UECM request message. The second row indicates the values of the IEs for the template. SCP 101 will use these values to build a synthetic SBI request message to send to a specific Nudm_UECM service instance.

When SCP 101 receives a response message from the Nudm_UECM service instance, SCP 101 verifies the information elements in the response by comparing the values of the information elements to values in a corresponding SBI response message template. Table 2 shown below illustrates examples of information elements that may be included in an SBI response message template for the Nudm_UEContextManagement service.

TABLE 2
Nudm_UEContextManagement Response Message Template

| HTTP | | 3gpp-Sbi- |
|---|---|---|
| Method | Location | Binding |
| 200 OK | Expected | Binding |
| | Location for | indicator, |
| | Nudm_UECM | NF instance |
| | service from | Id, NFSet Id |
| | routing table | from routing |
| | entry | table entry |

In Table 2, the first row represents the information elements that would be included in the response message for an AMF registration message for 3GPP access, which is one example of a request that can be fulfilled by the Nudm_UEContextManagement service. The second row indicates the values of the IEs for the template. SCP 101 will use these values to validate the received SBI response message. For example, SCP 101 will verify that the HTTP method type of the response message is 200 OK, that the expected location in the location header corresponds to the location in the routing table entry, and that the NF instance ID and the NF set ID in the 3 gpp-sbi-Binding header match the corresponding values in the routing table entry.

It should be noted that SCP 101 may, in addition to validating responses to individual SBI request messages, also validate SBI request messages in a set of SBI request messages that form an SBI transaction. For example, for the Nudm_UEContextManagement service, SCP 101 may validate a registration and deregistration transaction for the Nudm_UECM service. To initiate the validation, SCP 101 generated and sends a synthetic AMF registration for 3GPP access message to a Nudm_UECM service instance. After validating the registration portion of the transaction, SCP 101 may send a synthetic AMF deregistration for 3GPP access message to the Nudm_UECM service instance and verify that the AMF instance is successfully deregistered by the Nudm_UECM service instance.

In general, when SCP 101 creates a resource object, such as the registration resource object in the preceding example, on a producer NF service instance using synthetic monitoring, SCP 101 may also delete the resource object on the producer NF service instance. SCP 101 may delete the resource object once the result of the synthetic monitoring has been determined. SCP 101 may delete the resource object by sending an SBI request message to delete the resource object, such as the AMF deregistration for 3GPP access message in the preceding example.

SCP 101 generates synthetic SBI request messages for different producer NF services and periodically sends the SBI service request messages to the producer NF service instances. SCP 101 receives the responses received from individual producer NF service instances and compares the responses to expected response messages stored by SCP 101 as templates. The SCP verifies each of the header and IE values of the response messages. If the message content matches the expected values, then the corresponding NF producer service instance is marked as a healthy candidate for routing of SBI messages from consumer NF instances. If the response message is not received or does not include the correct IE values, the SCP considers the NF producer service instance as unhealthy and removes the producer NF service instance from routing rules for further routing of SBI messages until the NF producer service instance passes synthetic message validation. The SCP can also monitor latency of synthetic responses to determine the efficiency of NF producer service instances as candidates for routing the SBI messages from NF consumer service instances.

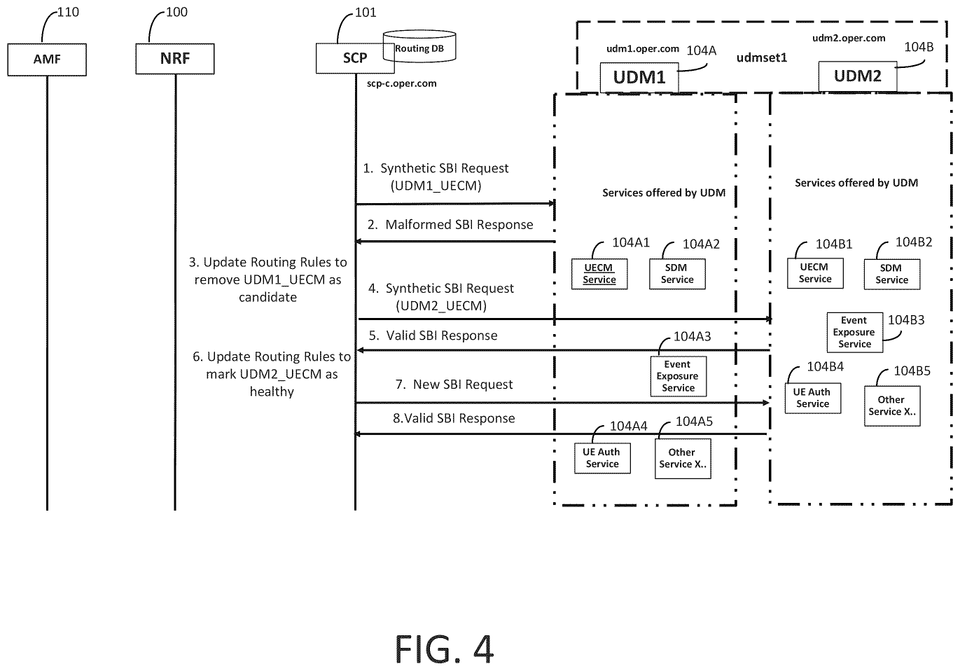

FIG. 4 is a message flow diagram illustrating the use of synthetic monitoring to monitor the status of NF service instances and the use of results of the synthetic monitoring to update routing rules used by the SCP to route SBI request messages. Referring to FIG. 4, and step 1, SCP 101 sends a synthetic SBI request message to Nudm_UECM service instance 104A1. In step 2, UDM_UECM service instance 104A1 returns a malformed SBI response message. In step 3, SCP 101 updates its routing rules to remove Nudm_UECM service instance 104A1 as a candidate for routing.

In step 4, SCP 101 generates and sends a synthetic SBI request message to Nudm_UECM service instance 104B1. In step 5, Nudm_UECM service instance 104B1 returns a valid SBI response message. In step 6, SCP 101 determines that the response is valid by comparing the values of the IEs in the response message to expected values in a corresponding response template and determining that the values match. In response to determining that the values match, SCP 101 updates its routing rules to indicate that Nudm_UECM service instance 104B1 is a healthy candidate to which SBI request messages can be routed. In step 7, SCP 101 sends a non-synthetic SBI request message to Nudm_UECM service 104B1. In step 8, Nudm_UECM service instance 104B1 returns a valid response message, thus avoiding the scenario illustrated in FIG. 3 where AMF 110 is required to re-initiate the request for Nudm_UECM service. SCP 101 may perform synthetic monitoring for all of the services illustrated in FIG. 4 and update its routing rules to reflect the status of each service.

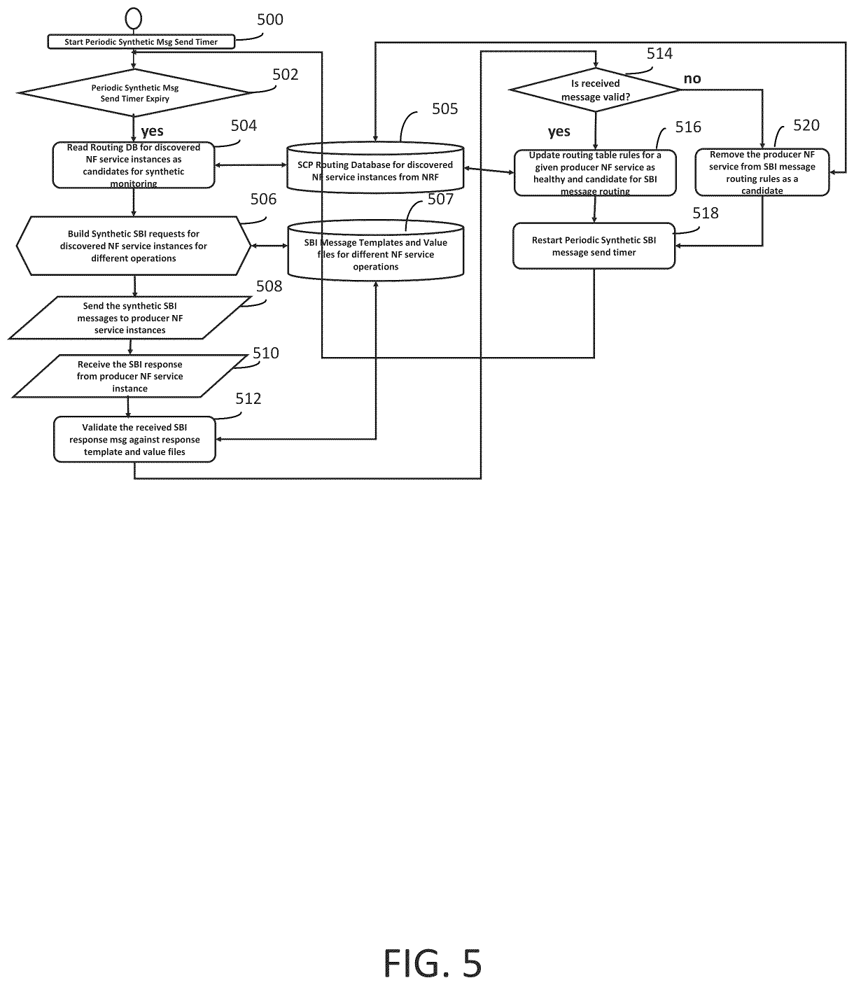

FIG. 5 is a flow chart illustrating an exemplary process performed by SCP 101 for using synthetic monitoring to monitor the status of NF service instances and to update routing rules. Referring to FIG. 5, in step 500, SCP 101 starts a periodic synthetic message send timer. In step 502, SCP 101 detects expiration of the periodic synthetic message send timer. In step 504, SCP 101 reads routing database 505 to identify discovered NF service instances as candidates for synthetic monitoring.

In step 506, SCP 101 builds synthetic SBI request messages for each discovered NF service instance for different operations and sends the messages. SCP 101 may build the messages using SBI request message templates stored in synthetic SBI message templates database 507. Synthetic SBI message templates database 507 stores information elements and information element values for each SBI request message types and response message types.

In step 508, SCP 101 sends the synthetic SBI request messages to message to the producer NF service instances. In step 510, SCP 101 receives an SBI response message from one of the producer NF service instance. In step 512, SCP 101 validates the received SBI response message against one of the SBI response message templates and value files stored in database 507.

In step 514, SCP 101 determines whether the received SBI message is valid. If the message is valid, control proceeds to step 516 where SCP 101 updates routing table rules in routing database 505 for the producer NF service instance for which the response message was received to indicate that the service instance is healthy and a candidate for SBI message routing. Control then proceeds to step 518 where SCP 101 restarts the periodic synthetic SBI message send timer and then control returns to step 502 to repeat the synthetic monitoring process when the timer expires again.

Returning to step 514, if SCP 101 determines that a received SBI response message is invalid, control proceeds to step 520 where SCP 101 removes the producer NF service instance as a candidate to which SBI request messages should be routed. Control then proceeds to step 518 with the periodic synthetic SBI message send timer is restarted. SCP 101 then returns to step 502 to restart the synthetic monitoring process when the timer expires again. It should be noted that steps 510-518 may be performed for each SBI response message received in response to one of the synthetic SBI request messages transmitted in step 508.

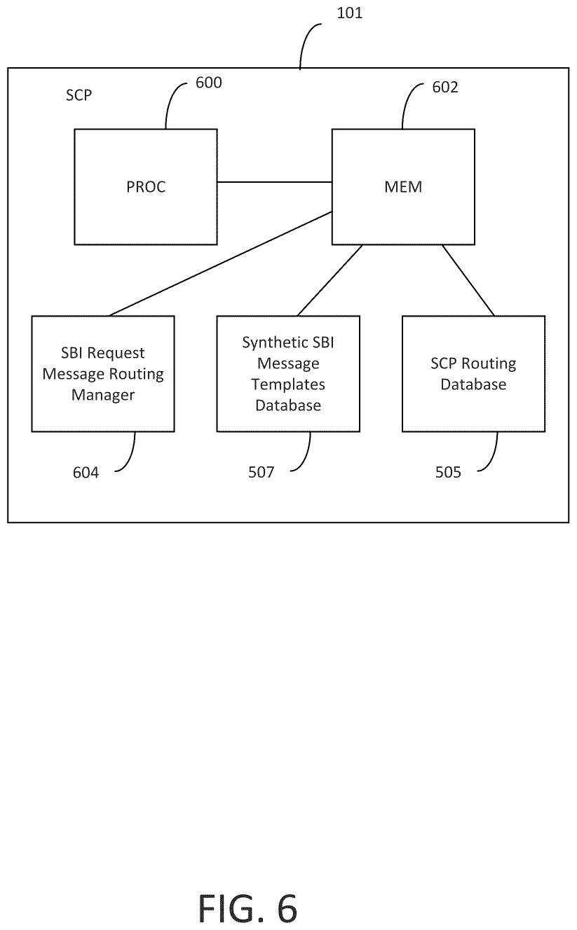

FIG. 6 is a block diagram illustrating an exemplary architecture of an SCP for performing synthetic monitoring and using the synthetic monitoring to update routing rules. Referring to FIG. 6, SCP 101 includes at least one processor 600 and memory 602. SCP 101 further includes SCP routing database 505 including routing rules that identify candidates for SCP message routing. The routing rules in SCP routing database 505 may be created using information obtained from NRF 100 via the NF discovery service operation. The routing rules may be initially populated with health status information obtained from NRF 100 in NF discovery response messages. SCP routing database 505 may also be updated using OCI/LCI obtained from producer NFs in SBI response messages. The health status information stored in SCP routing database 505 may also be updated using results obtained from synthetic monitoring as described herein. SCP 101 further includes synthetic SBI message templates database 507 that stores information for creating synthetic SBI request messages of various types and validating SBI response messages. SCP 101 further includes an SBI request message routing manager 604 that performs the steps described herein for synthetic monitoring and updating of SCP routing database 505 based on results of the synthetic monitoring. In one example, SBI request message routing manager 604 may be implemented using computer executable instructions stored in memory 602 and executed by processor 600.

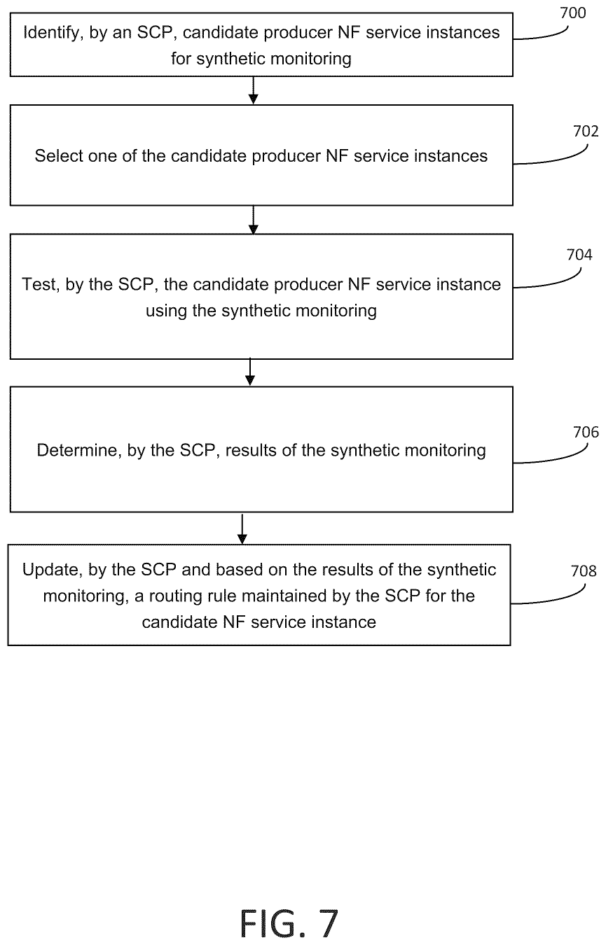

FIG. 7 is a flow chart illustrating an exemplary process for performing synthetic monitoring and using results of the synthetic monitoring to update routing rules. Referring to FIG. 7, in step 700, the process includes identifying, by an SCP, candidate producer NF service instances for synthetic monitoring. For example, SCP 101 may receive NF profiles of producer NF instances from NRF 100. The NF profiles may include NF service profiles of producer NF service instances of each producer NF instance. SCP 101 may create a routing database entry for each producer NF service instance whose service information is received from an NRF and is identified as REGISTERED and having available processing capacity.

In step 702, the process includes selecting one of the candidate producer NF service instances. For example, SCP 101 may select one of the routing rules in the routing rules database to identify the first candidate producer NF service instance to be tested.

In step 704, the process includes testing, by the SCP, the candidate producer NF service instance using the synthetic monitoring. For example, based on the service type of the candidate NF service instance, SCP 101 may select a synthetic SBI request message template, generate a corresponding synthetic SBI request message using the template, transmit the SBI request message to the candidate producer NF service instance, and receive a corresponding SBI response message from the candidate producer NF service instance.

In step 706, the process includes determining, by the SCP, results of the synthetic monitoring. For example, SCP 101 may compare information elements in the SBI response message to information elements in a corresponding SBI response message template and determine whether the information elements match. If all of the information elements match, SCP 101 may determine that the response is valid. If any of the information elements do not match, SCP 101 may determine that the response is invalid.

In step 708, the process includes updating, by the SCP and based on the results of the synthetic monitoring, a routing rule for the candidate producer NF service instance. For example, if SCP 101 determines that the response is valid, SCP 101 may update the routing rule for the candidate producer NF service instance to indicate that the producer NF service instance is healthy. If SCP 101 determines that the response is invalid or no response is received within a timeout period, SCP 101 may either update the routing rule to identify the candidate producer NF service instance as unhealthy or delete the routing rule from the routing database.

Exemplary advantages of the subject matter described herein include the ability to detect false health status of producer NF instance reported to NRF by verifying the actual working behavior of producer NF service instance through synthetic messages without impacting the actual SBI message processing received from NF consumer service instances. Another advantage of synthetic monitoring is that it validates the compliance of behavior of individual producer NF service instances by verifying the individual IE values of SBI response messages for different NF producer service instances. Yet another advantage of synthetic monitoring is that it avoids or reduces the impact on end 5G services by early detection of incorrect behavior of producer NF service instances. Yet another advantage of synthetic monitoring by the SCP is that it reduces the need for NF consumer instances to validate producer NF service instance behavior. Yet another advantage of synthetic monitoring is that it reduces the need for re-initiation of end to end 5G service procedures due to incorrect responses of specific producer NF services and hence improves overall network efficiency of 5G core network service procedures.

In summary, the subject matter described herein enables enhanced routing decisions at the SCP using synthetic monitoring in conjunction with NRF-based NF information to select producer NF service instances for routing of SBI messages received from consumer NF instances, which ensures more successful processing of SBI messages for different end-to-end 5G service procedures. As a result, the likelihood of service outages and impacts to end mobile subscriber 5G services due to incorrect behavior of specific producer NF service instances of 5G core network is decreased.

The disclosure of each of the following references is hereby incorporated herein by reference in its entirety.

### REFERENCES

1. 3^{rd} Generation Partnership Project; Technical Specification Group Core Network and Terminals; 5G System; Network Function Repository Services; Stage 3 (Release 18) 3GPP TS 29.510 V18.4.0 (2023-09)
2. 3^{rd} Generation Partnership Project; Technical Specification Group Services and System Aspects; System architecture for the 5G System (5GS); Stage 2 (Release 18) 3GPP TS 23.501 V18.4.0 (2023-12)
3. 3^{rd} Generation Partnership Project; Technical Specification Group Core Network and Terminals; 5G System; Unified Data Management Services; Stage 3 (Release 18) 3GPP TS 29.503 V18.4.0 (2023-12)

It will be understood that various details of the subject matter described herein may be changed without departing from the scope of the subject matter described herein. Furthermore, the foregoing description is for the purpose of illustration only, and not for the purpose of limitation, as the subject matter described herein is defined by the claims as set forth hereinafter.

What is claimed is:

1. A method for synthetic monitoring and updating of routing rules by a service communication proxy (SCP), the method comprising:
identifying, by an SCP, candidate producer NF service instances for synthetic monitoring; and
for each of the candidate producer NF service instances:
testing, by the SCP, the candidate producer NF service instance using the synthetic monitoring;
determining, by the SCP, results of the synthetic monitoring; and
updating, by the SCP and based on the results of the synthetic monitoring, routing rules in a routing database maintained by the SCP.

2. The method of claim 1 wherein identifying candidate producer NF service instances for synthetic monitoring includes:
receiving, from an NF repository function (NRF) NF discovery responses including NF service profiles of the candidate producer NF service instances;
creating, from the NF service profiles, a routing database including routing rules for routing SBI request messages to the candidate producer NF service instances; and
selecting the candidate producer NF service instances from the routing database.

3. The method of claim 1 wherein testing the candidate producer NF service instance using synthetic monitoring includes:
generating, for the candidate producer NF service instance, at least one synthetic service-based interface (SBI) request message;
transmitting the at least one synthetic SBI request message to the candidate producer NF service instance; and
receiving at least one SBI response message to the at least one synthetic SBI request message.

4. The method of claim 3 comprising maintaining, by the SCP, SBI response message templates, wherein determining the results of the synthetic monitoring includes:
comparing information elements in the at least one SBI response message to information elements in at least one of the SBI response message templates;
determining that the candidate producer NF service instance as healthy when the information elements in the at least one SBI response message match the information elements in the at least one SBI response message template; and
determining that the candidate producer NF service instance as unhealthy when at least one of the information elements in the at least one SBI response message does not match at least one of the information elements in the at least one SBI response message template.

5. The method of claim 4 wherein updating the routing rules includes indicating that the candidate producer NF service instance is healthy when the candidate producer NF service instance is determined to be healthy.

6. The method of claim 4 wherein updating the routing rules includes removing a routing rule for the candidate producer NF service instance from the routing database or indicating that the candidate producer NF service instance is unhealthy when the candidate producer NF service instance is determined to be unhealthy.

7. The method of claim 3 comprising, maintaining, by the SCP, synthetic SBI request message templates and wherein generating the at least one synthetic SBI request message includes generating the at least one synthetic SBI request message using at least one of the synthetic SBI request message templates.

8. The method of claim 1 comprising, after completion of the synthetic monitoring of one of the producer NF service instances, deleting a resource object created by the synthetic monitoring of the one producer NF service instance.

9. The method of claim 3 wherein:
generating the at least one synthetic SBI request message includes generating a plurality of synthetic SBI request messages that form an SBI transaction;
transmitting at least one synthetic SBI request message to the candidate producer NF service instance includes transmitting the plurality of synthetic SBI request messages to the candidate producer NF service instance;
receiving at least one SBI response message to the at least one synthetic SBI request message includes receiving SBI response messages to the synthetic SBI request messages; and
determining results of the synthetic monitoring includes identifying the candidate producer NF service instance as healthy when the candidate producer NF service instance generates expected SBI response messages to each of the synthetic SBI request messages that form the SBI transaction and identifying the candidate producer NF service instance as unhealthy when the candidate producer NF service instance fails to generate an expected SBI response message to at least one of the synthetic SBI request messages that form the SBI transaction.

10. The method of claim 1 wherein:
testing the candidate producer NF service instance using the synthetic monitoring includes periodically testing the candidate producer NF service instance using the synthetic monitoring;
determining results of the synthetic monitoring includes periodically determining results of the synthetic monitoring; and
updating the routing rules maintained by the SCP includes periodically updating the routing rules maintained by the SCP.

11. A system for synthetic monitoring and updating of routing rules, the system comprising:
a service communication proxy (SCP) including at least one processor and a memory; and
a service-based interface (SBI) request message routing manager implemented by the at least one processor for identifying, by an SCP, candidate producer NF service instances for synthetic monitoring and, for each of the candidate producer NF service instances: testing the candidate producer NF service instance using the synthetic monitoring, determining, results of the synthetic monitoring; and updating, based on the results of the synthetic monitoring, routing rules in a routing database maintained by the SCP.

12. The system of claim 11 wherein, in identifying the candidate producer NF service instances for synthetic monitoring, the SBI request message routing manager is configured to:
receive, from an NF repository function (NRF) NF discovery responses including NF service profiles of the candidate producer NF service instances;
create, from the NF service profiles, a routing database including routing rules for routing SBI request messages to the candidate producer NF service instances; and
select the candidate producer NF service instances from the routing database.

13. The system of claim 11 wherein, in testing the candidate producer NF service instance using synthetic monitoring, the SBI request message routing manager is configured to:
generate, for the candidate producer NF service instance, at least one synthetic service-based interface (SBI) request message;
transmit the at least one synthetic SBI request message to the candidate producer NF service instance; and
receive at least one SBI response message to the at least one synthetic SBI request message.

14. The system of claim 13 wherein the SBI request message routing manager is configured to maintain SBI response message templates, and, in determining the results of the synthetic monitoring the SBI request message routing manager is configured to:
compare information elements in the at least one SBI response message to information elements in at least one of the SBI response message templates;
determine that the candidate producer NF service instance as healthy when the information elements in the at least one SBI response message match the information elements in the at least one SBI response message template; and
determine that the candidate producer NF service instance as unhealthy when at least one of the information elements in the at least one SBI response message does not match at least one of the information elements in the at least one SBI response message template.

15. The system of claim 14 wherein:
in updating the routing rules, the SBI request message routing manager is configured to indicate that the candidate producer NF service instance is healthy when the candidate producer NF service instance is determined to be healthy; and
in updating the routing rules the SBI request message routing manager is configured to remove a routing rule for the candidate producer NF service instance from the routing database or indicate that the candidate producer NF service instance is unhealthy when the candidate producer NF service instance is determined to be unhealthy.

16. The system of claim 13 wherein the SBI request message routing manager is configured to maintain synthetic SBI request message templates and, in generating the at least one synthetic SBI request message, the SBI request message routing manager is configured to generate generating the at least one synthetic SBI request message using at least one of the synthetic SBI request message templates.

17. The system of claim 11 wherein the SBI request message routing manager is configured to, after completion of the synthetic monitoring of one of the producer NF service instances, deleting a resource object created by the synthetic monitoring of the one producer NF service instance.

18. The system of claim 13 wherein:
in generating the at least one synthetic SBI request message, the SBI request message routing manager is configured to generate a plurality of synthetic SBI request messages that form an SBI transaction;
in transmitting at least one synthetic SBI request message to the candidate producer NF service instance, the SBI request message routing manager is configured to transmit the plurality of synthetic SBI request messages to the candidate producer NF service instance;
in receiving at least one SBI response message to the at least one synthetic SBI request message, the SBI request message routing manager is configured to receive SBI response messages to the synthetic SBI request messages; and
in determining results of the synthetic monitoring, the SBI request message routing manager is configured to identify the candidate producer NF service instance as healthy when the candidate producer NF service instance generates expected SBI response messages to each of the synthetic SBI request messages that form the SBI transaction and identify the candidate producer NF service instance as unhealthy when the candidate producer NF service instance fails to generate an expected SBI response message to at least one of the synthetic SBI request messages that form the SBI transaction.

19. The system of claim 11 wherein:
in testing the candidate producer NF service instance using the synthetic monitoring, the SBI request message routing manager is configured to periodically test the candidate producer NF service instance using the synthetic monitoring;
in determining results of the synthetic monitoring, the SBI request message routing manager is configured to periodically determine results of the synthetic monitoring; and
in updating the routing rules maintained by the SCP, the SBI request message routing manager is configured to periodically updating the routing rules maintained by the SCP.

20. A non-transitory computer readable medium having stored thereon executable instructions that when executed by a processor of a computer control the computer to perform steps comprising:
identifying, by a service communication proxy (SCP), candidate producer network function (NF) service instances for synthetic monitoring; and
for each of the candidate producer NF service instances:
testing, by the SCP, the candidate producer NF service instance using the synthetic monitoring;
determining, by the SCP, results of the synthetic monitoring; and
updating, by the SCP and based on the results of the synthetic monitoring, routing rules in a routing database maintained by the SCP.
